(19) United States
(12) Patent Application Publication
(10) Pub. No.: US 2015/0382395 A1
(43) Pub. Date: Dec. 31, 2015

(54) Method For Recovering From PDCP HFN De-Synchronization For VoLTE Call And Data Failure In RLC Layer

(71) Applicant: Alcatel-Lucent USA Inc., Murray Hill, NJ (US)

(72) Inventors: Yang Yang, Morris Plains, NJ (US); Xin Wang, Morris Plains, NJ (US)

(73) Assignee: ALCATEL-LUCENT USA INC., Murray Hill, NJ (US)

(21) Appl. No.: 14/319,525

(22) Filed: Jun. 30, 2014

(51) Int. Cl. H04W 76/02; H04W 36/30

(52) U.S. Cl. CPC H04W 76/028; H04W 36/30; H04W 36/08

(57) ABSTRACT

A method and/or device that determines when an erroneous voice packet has been received over the air interface of a cellular communication network, such as a 4G LTE network, and initiates a voice communications re-establishment procedure when a triggering event—based on receptions of erroneous voice packets—has occurred. The voice communications re-establishment procedure is performed to avoid at least a portion of the air interface (i.e., an uplink or downlink of the Uu interface through which the erroneous voice packets have traversed) from becoming non-operational. The triggering event may be the number of consecutive erroneous voice packets received over an uplink or downlink surpassing a threshold or it may be the length of time that has lapsed during receptions of consecutive erroneous voice packets. The triggering event is an indication that an uplink or downlink will most likely become non-operational if voice communications are not re-established.

### FIELD OF THE INVENTION

The present invention generally relates to cellular wireless communication networks and in particular to a method for avoiding uplink or downlink failure of air interfaces of wireless communication networks.

### BACKGROUND OF THE INVENTION

Many cellular communication network service providers will be providing digital voice services through packet switching instead of using the established circuit switching method. With the advent of the full 4G (Fourth Generation) LTE (Long Term Evolution) networks, voice services in many such networks will be provided through the use of digital voice packets. Many such service providers are embarking on this new type of voice service with the desire that the quality of service (QoS) and the quality of experience (QoE) for their customers at least remain the same or even improve. In preparation for the launch of voice over LTE (or VoLTE), service providers are currently testing the overall effectiveness and quality of service of their VoLTE networks. Many service providers have discovered that their 4G LTE cellular networks experience air interface link failures during voice telephone calls between UEs (User Equipment, e.g., cellular phones) under circumstances where such telephone calls were typically handled quite well by legacy 2G (Second Generation) and 3G (Third Generation) networks. Also, while many of the calls are not dropped, either one of the links (UL-uplink or DL-downlink) becomes non-operational leading to the waste of system resources until one of the parties to the call decides to terminate the call. Furthermore, upon initial inspection of these link failures, it appears that 4G LTE cellular networks are not adequately equipped or operated with mechanisms to detect the occurrence of link failures and quickly determine the cause of such failures. In many such occurrences, one of the parties to the telephone call is unable to hear the other party or vice versa. During this period of confusion, the telephone call has not been terminated and thus resources of the network that are being used to maintain the telephone call are, in effect, being wasted. Also, because the breakdown of communications is in one of the links of the air interface, either one or both of the parties will soon realize that the telephone call is not providing two-way communications. As a result, either one or both of the parties may terminate the call, but only after several seconds (or maybe even minutes) have lapsed resulting in not only in the waste of system resources, but in a diminished QoS and QoE for the users.

### BRIEF SUMMARY OF THE INVENTION

The method of the present invention provides an approach for recovering from a link failure or avoiding a link failure over an air interface of a cellular network whereby during an established communication session, the method and device of the present invention monitors voice packets received over the link to determine if a triggering event has occurred where such triggering event indicates the likelihood of the link becoming non-operational. Upon the reception of an erroneous voice packet over the link, the method and device of the present invention initiate a voice communications re-establishment procedure over the air interface. In one embodiment, the triggering event is deemed to have occurred when the number of consecutive erroneous voice packets received surpasses a network defined threshold. In another embodiment of the method and device of the present invention, the triggering event is deemed to have occurred when a timer, initiated by the reception of an erroneous voice packet, has lapsed; the time duration of the timer is a network defined threshold. The network defined time duration and threshold are adjustable.

In a second embodiment, the established communication session is operated in accordance with at least one protocol that is part of a communication standard with which the cellular network complies. The cellular network may be, for example, a 4G LTE (Long Term Evolution) network where the at least one protocol is the IP (Internet Protocol) and the air interface is the Uu interface. For the case where the cellular is a 4G LTE network, the voice packets are being received over either the uplink or the downlink of the Uu interface.

The device of the present invention comprises a processor coupled to a receiver whereby such a device may reside in or be part of a mobile terminal or a base station either one of which is directly coupled to the air interface of the cellular network to allow them to receive voice packets. The processor processes the received voice packets in accordance with at least one protocol of the air interface. The term “couple” refers to a path allowing electrical, electronic, optic, electromagnetic and other types of signals to travel from one node (within equipment in a network) to another node of the same or different network. A node refers to equipment, which may be integrally combined with other equipment to form a singular piece of equipment. A first node is said to be directly coupled to a second node when there are no other equipment, network elements or nodes positioned between the first and second nodes.

In a third embodiment, the method of the present invention provides an approach for determining the reception of erroneous data packets over an air interface of a cellular network during an established communication session operated in accordance with at least one protocol that is part of a communication standard with which the cellular network complies. The method of the present invention uses a defined protocol to transmit ACK/NACK messages to a network element transmitting data packets. When an erroneous data packet (i.e., a packet containing errors) is received, a NACK message is transmitted to the network element that transmitted the packet; that network element retransmits the packet and also increments a retransmit counter that counts the number of times the packet has been retransmitted. Once the number of retransmissions surpasses a threshold, a triggering event is declared. The threshold can be a network defined threshold; it can be, for example, a number reflecting a confidence level of the network provider regarding the quality of the link through which the data is being transmitted. Further, upon the reception of an erroneous data packet, the method of the present invention initiates a NACK timer set to run for a defined period of time. If the NACK timer lapses without an ACK message having been received, a triggering event is deemed to have occurred. Upon the occurrence of a triggering event, the method of the present invention initiates a data communications re-establishment procedure to prevent at least a portion of the air interface (through which the data packets are being transmitted) from becoming non-operational.

The time duration of the timer is a network defined threshold, which can be adjusted as needed by operators of the network. In a further embodiment, the cellular network is a 4G LTE network where the at least one protocol is an RLC (Radio Link Control) protocol and the network element receiving the data packets is an eNodeB; in such a case the data communications re-establishment procedure is a handover initiated by the eNodeB. The packets are being received over the uplink of the Uu interface.

The establishment of voice communications or data communications or both comprises the steps of the network registering a network element (e.g., mobile terminal device, base station), entering into a subscription agreement with the owner/operator (or confirming such a subscription agreement is in effect) of the network so as to recognize the network element and providing the network element access to resources of the network in accordance with one or more protocols being followed by the network; the network element can then use the resources of the network to transmit and/or receive information during a communication session (e.g., a telephone call). A communication session is the actual occurrence of conveyance of information (transmission/reception of user and/or network information) between at least two network elements. A network element is equipment that is permanently or temporarily part of the cellular communication network and performs a defined set of functions during a communications session. A network element may be, for example, a mobile terminal (i.e., a UE in 4G parlance), or a base station. Once voice communications have been established, a network element may conduct a communication session (e.g., a telephone conversation) with another network element of the network. Further, voice communications between network elements (e.g., base station, mobile terminal) are established as per one or more protocols of the standards with which the device and method of the present invention comply.

### BRIEF DESCRIPTION OF THE DRAWINGS

FIG. 1 shows portions of a 4G LTE cellular communication network.

FIG. 2 shows a protocol stack as per a standard for air interfaces of the network of FIG. 1.

FIG. 3 is a block diagram showing the various steps performed by one of the protocols (PDCP) of the protocol stack of FIG. 2.

FIG. 4 depicts the contents of a register representing some of the processing performed by the protocol of FIG. 3

FIG. 5 is a flow chart of one embodiment of the method of the present invention as performed by a mobile terminal that has established communications with the cellular network of FIG. 1.

FIG. 6 is a flow chart of another embodiment of the method of the present invention as performed by a base station that is part of the cellular network of FIG. 1.

FIG. 7 is a flow chart of yet another embodiment of the method of the present invention as performed by a base station that is part of the cellular network of FIG. 1.

### DETAILED DESCRIPTION

The method of the present invention provides an approach for recovering from a link failure or avoiding a link failure over an air interface of a cellular network whereby during an established communication session, the method and device of the present invention monitors voice packets received over the link to determine if a triggering event has occurred where such triggering event indicates the likelihood of the link becoming non-operational. Upon the reception of an erroneous voice packet over the link, the method and device of the present invention initiate a voice communications re-establishment procedure over the air interface. In one embodiment, the triggering event is deemed to have occurred when the number of consecutive erroneous voice packets received surpasses a network defined threshold. In another embodiment of the method and device of the present invention, the triggering event is deemed to have occurred when a timer, initiated by the reception of an erroneous voice packet, has lapsed; the time duration of the timer is a network defined threshold. The network defined time duration and threshold are adjustable.

In a second embodiment, the established communication session is operated in accordance with at least one protocol that is part of a communication standard with which the cellular network complies. The cellular network may be, for example, a 4G LTE (Long Term Evolution) network where the at least one protocol is the IP (Internet Protocol) and the air interface is the Uu interface. For the case where the cellular is a 4G LTE network, the voice packets are being received over either the uplink or the downlink of the Uu interface.

The device of the present invention comprises a processor coupled to a receiver whereby such a device may reside in or be part of a mobile terminal or a base station either one of which is directly coupled to the air interface of the cellular network to allow them to receive voice packets. The processor processes the received voice packets in accordance with at least one protocol of the air interface. The term “couple” refers to a path allowing electrical, electronic, optic, electromagnetic and other types of signals to travel from one node (within equipment in a network) to another node of the same or different network. A node refers to equipment, which may be integrally combined with other equipment to form a singular integral equipment. A first node is said to be directly coupled to a second node when there are no other equipment, network elements or nodes positioned between the first and second nodes.

In a third embodiment, the method of the present invention provides an approach for determining the reception of erroneous data packets over an air interface of a cellular network during an established communication session operated in accordance with at least one protocol that is part of a communication standard with which the cellular network complies. The method of the present invention uses a defined protocol to transmit ACK/NACK messages to a network element transmitting data packets. When an erroneous data packet (i.e., a packet containing errors) is received, a NACK message is transmitted to the network element that transmitted the packet; that network element retransmits the packet and also increments a retransmit counter that counts the number of times the packet has been retransmitted. Once the number of retransmissions surpasses a threshold, a triggering event is declared. The threshold can be a network defined threshold; it can be, for example, a number reflecting a confidence level of the network provider regarding the quality of the link through which the data is being transmitted. Further, upon the reception of an erroneous data packet, the method of the present invention initiates a NACK timer set to run for a defined period of time. If the NACK timer lapses without an ACK message having been received, a triggering event is deemed to have occurred. Upon the occurrence of a triggering event, the method of the present invention initiates a data communications re-establishment procedure to prevent at least a portion of the air interface (through which the data packets are being transmitted) from becoming non-operational.

The time duration of the timer is a network defined threshold, which can be adjusted as needed by operators of the network. In a further embodiment, the cellular network is a 4G LTE network where the at least one protocol is an RLC (Radio Link Control) protocol and the network element receiving the data packets is an eNodeB; in such a case the data communications re-establishment procedure is a handover initiated by the eNodeB. The packets are being received over the uplink of the Uu interface.

The establishment of voice communications or data communications or both comprises the steps of the network registering a network element (e.g., mobile terminal device, base station), entering into a subscription agreement with the owner/operator (or confirming such a subscription agreement is in effect) of the network so as to recognize the network element and providing the network element access to resources of the network in accordance with one or more protocols being followed by the network; the network element can then use the resources of the network to transmit and/or receive information during a communication session (e.g., a telephone call). A communication session is the actual occurrence of conveyance of information (transmission/reception of user and/or network information) between at least two network elements. A network element is equipment that is permanently or temporarily part of the cellular communication network and performs a defined set of functions during a communications session. A network element may be, for example, a mobile terminal (i.e., a UE in 4G parlance), or a base station. Once voice communications have been established, a network element may conduct a communication session (e.g., a telephone conversation) with another network element of the network. Further, voice communications between network elements

For ease of explanation, the method of the present invention will be described in the context of a cellular communication network operating in accordance with the 4G LTE standard including its plethora of protocols. In particular, the method of the present invention will focus on the air interface (also called the ‘radio interface’ with constituent parts referred to as the “uplink” and the “downlink” described hereinafter) of the network and provide a solution to the problems experienced by the air interface in providing voice communications and data communications to subscribers of the network. It should be noted that the method of the present invention is not limited to cellular networks operated in accordance with the 4G LTE standard, but is applicable to other cellular networks that provide at least voice and data services at least over air interfaces. The term ‘interface’ refers to a logical entity that represents or can perform a transfer of information from one network point (element or equipment) to another network point of the same network or different network in accordance with one or more protocols. A protocol is a set of rules and/or steps on how a particular task is to be done in accordance with a standard. In the context of an interface, a protocol is a defined procedure on how the information being transferred via an interface is to be formatted (i.e., arranged), transmitted, received and processed by the network nodes at each end of the interface.

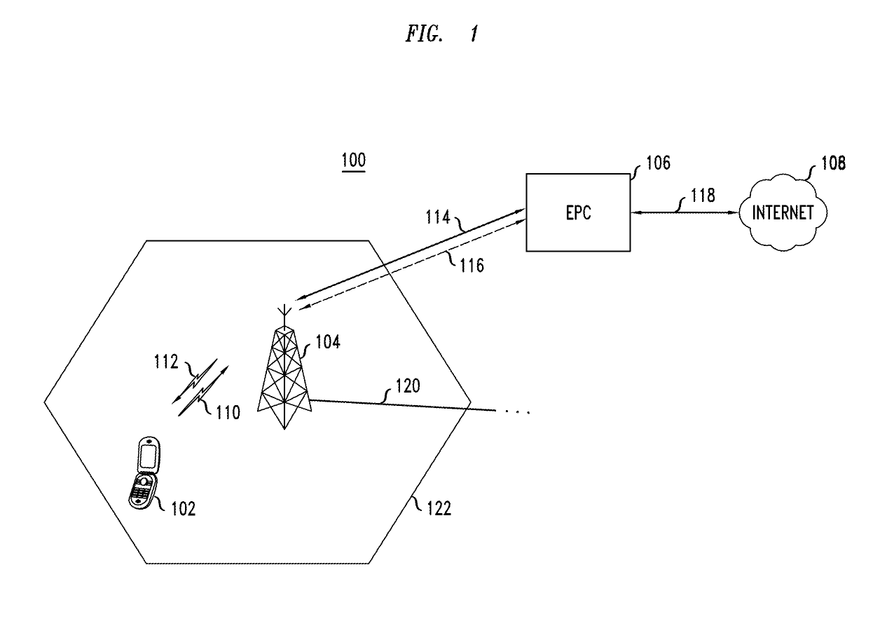

Referring to FIG. 1, a portion of a typical 4G LTE network is shown. In particular, a base station (eNodeB 104) servicing cell 122 is connected to the EPC (Evolved Packet Core) 106 portion of the network via user and signaling interfaces 114 and 116 respectively as shown. For LTE networks, interface 114 is referred to as an S1-u interface and interface 116 is referred to as an S1-MME (Mobility Management Entity) interface. Interface 120 is referred to as an X2 interface and interface 118 is referred to as the SGi interface. Interface X2 connects eNodeB 104 to a neighboring eNodeB serving a neighboring cell (not shown). The EPC 106 comprises several network elements that are used to process user information (e.g., voice, data, multimedia, graphics) and to process signaling information used to establish communications between UEs and the network and also to control, manage, specify, and/or modify the particular services provided to the subscribers to the network. Interfaces depicted with solid lines transfer user information or user traffic. Interfaces depicted with dashed lines transfer signaling information.

Subscribers to the network gain access to the network via the air interface. A UE 102 (user equipment, e.g., smart phone, laptop, notebook) located within a cell being served by a base station (e.g., eNodeB 104) establishes communications with the eNodeB 104 and thus the network, and is then able to transmit and/or receive information (user data, network signaling information) to/from the network. A cell is a geographic area within which at least one eNodeB operates and provides UEs physically located within the cell access to the cellular network via the air interface. In FIG. 1 UE 102 is located within cell 122. The air (or radio) interface for 4G LTE is also referred to as the Uu interface, which comprises an uplink and a downlink. Hereinafter, the terms ‘radio interface,’ ‘air interface,’ and ‘Uu interface’ will be used interchangeably. The UE 102 and eNodeB may be coupled or directly coupled to the air interface (links 110, 112).

An uplink is a portion of the Uu interface wherein information (i.e., user data or network signaling information) is transmitted over a wireless radio interface from a UE to the base station (i.e., eNodeB) where the UE is physically located in the cell being serviced by the base station. A downlink is a portion of the Uu interface wherein information is transmitted over a wireless radio interface from a base station to a UE where the UE is located within the cell being serviced by the base station. Accordingly, eNodeB 104 is servicing cell 122 and therefore UE 102 obtains access to the network via uplink 110 and downlink 112.

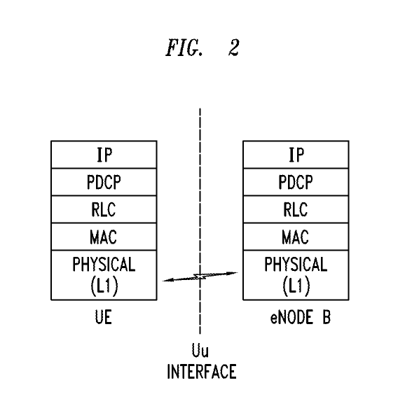

The transfer of information through an interface is typically dictated by one or more protocols. For the radio interface of a 4G LTE network, there is a stack of protocols interrelated to each other and each protocol is represented by a layer of the stack. Referring to FIG. 2, the various protocols that dictate the operation of the Uu interface are shown. A UE and an eNodeB are positioned at the respective ends of the Uu interface. Information, in the form of IP packets, originate from either the eNodeB or the UE and upon being transferred via the Uu interface, these IP packets are processed by the various protocols shown. The protocols are the Internet Protocol (IP), the Packet Data Convergence Protocol (PDCP), the Radio Link Control (RLC) protocol, the Medium Access Control (MAC) protocol and a physical signal protocol commonly referred to as the L1 protocol. An IP packet transmitted by the UE to the eNodeB is first processed by the transmit portions of each of the protocols resident in the UE and the IP packet is transmitted by the UE over the uplink to the eNodeB where the receive portion of the stack of protocols resident in the eNodeB processes the packet. The same protocols (for transmission and reception) of voice signals reside in both the UE and eNodeB as shown in FIG. 2. Conversely, an IP packet transmitted by the eNodeB to the UE is first processed by the transmit portion of the stack of protocols resident in the eNodeB and the IP packet is then transmitted by the eNodeB over the downlink to the UE where it is processed by the receive portion of the stack of protocols resident in the UE as shown in FIG. 2. It should be noted that the uppermost layer shown here as the IP layer can be also a UDP (User Datagram Protocol), which is part of the suite of Internet protocols. The upper layer can be a combination of UDP/IP.

It will readily understood by those skilled in this art that voice packets transmitted over an air interface will, at times, be adversely affected by various anomalies present in the wireless communication channel. As a result, many of the voice packets transmitted by the UE to the eNodeB (over the uplink) may not reach the eNodeB or they may be so distorted that their voice information is tantamount to a noise signal. The same deleterious effects of the communication channel may cause the occurrence of erroneous packets or lost packets in the downlink as well. An ACK/NACK (Acknowledgement/Negative acknowledgement) procedure typically used for data packets whereby data packets, which have not been received or which are received in error, are retransmitted when the receiving party sends a NACK message indicating that the data packet was received in error or was never received at all. The transmission of the NACK is also a request by the receiving party to the transmitting party to re-transmit the data packet. Because of the nature of voice signals, such an ACK/NACK procedure would disrupt the continuous flow of voice signals needed for proper voice transmission and reception. As a result, the various 4G LTE standard protocols used in processing voice operate in an unacknowledged mode. Because of this approach to operate in an unacknowledged mode, it is difficult to detect when the occurrences of packet losses or erroneous packets will likely result in an uplink and/or downlink failure.

The method of the present invention uses the manner in which voice packets are processed by the PDCP (for example, as defined in the 3GPP TS 36.323-100 Packet Data Convergence Protocol specification (release 8), Sep. 24, 2007 which is incorporated herein by reference in its entirety) to determine when the likelihood of an uplink or downlink failure exists for a certain communication session. The cited TS (Technical Specification) and all other TS cited herein are part of a communication standard(s).

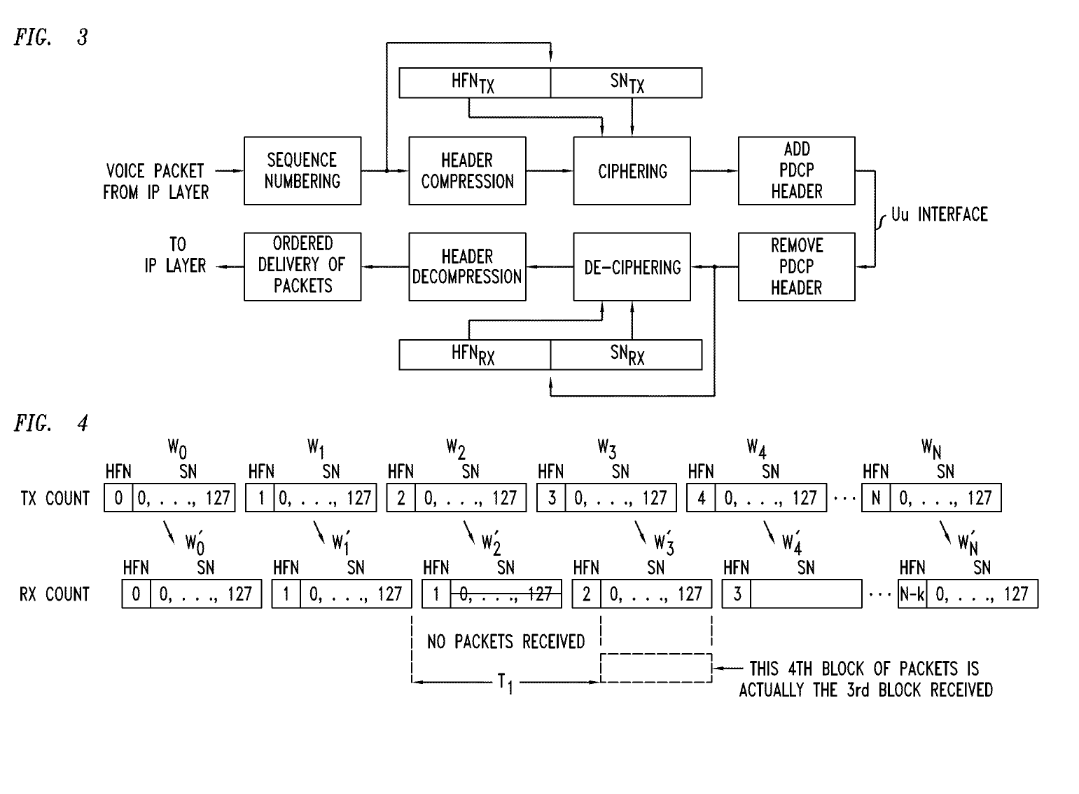

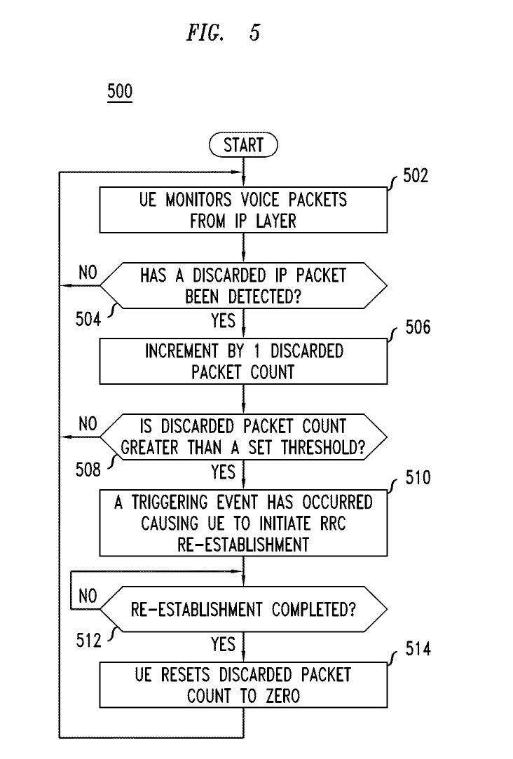

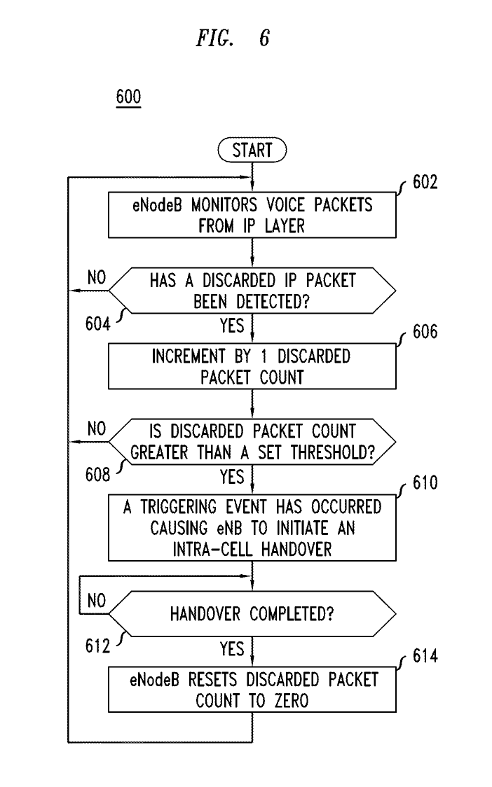

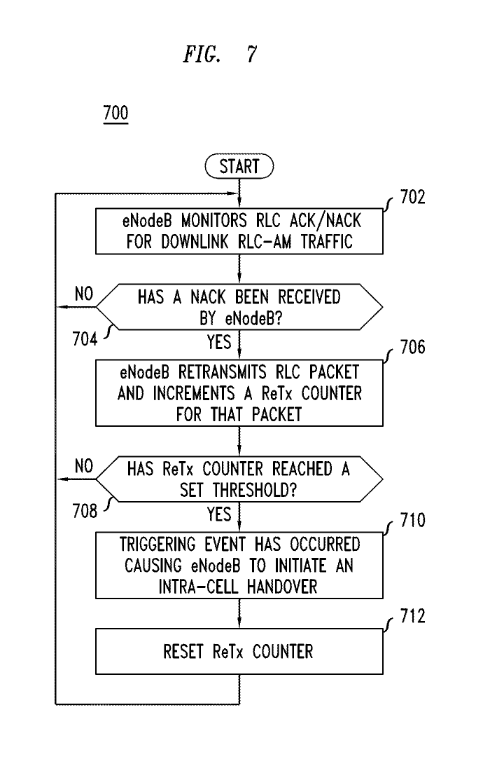

Referring to FIG. 3, a block diagram representing the main steps performed by the PDCP is shown (see, for example, FIG. 4.2.2.1 of sec. 4.2.2 of TS 36.323-100 rel. 8). The PDCP and the various other protocols of FIG. 2 reside in both the UE and the eNodeB and thus, the block diagram of FIG. 3 represents the steps performed by both the UE and eNodeB. At the PDCP layer transmit end, each voice packet entering from the IP layer is assigned a sequence number (SN). For example, in the TS 36.323-200, release 8, sec. 6.3.2 protocol, which is also incorporated herein by reference in its entirety, the SN can be selected to be 7 bits in length and thus the SN value starts at 0 and ends at 127. Further, an HFN (Hyper Frame Number) is defined to start at 0 and is incremented by 1 after every 128 packets that enter the PDCP layer. A variable “COUNT” comprising the SN and HFN (see, for example, TS 36.323-100, Release 8, sec. 6.3.4, FIG. 5.2.1 or for example, TS 36.323-200, Release 8, sec. 6.3.5, FIG. 6.3.5.1) is used as input to the header compression—which we will assume to be disabled for this part of the discussion—and the ciphering process of the packet as shown. In other words, after the SN and HFN have been generated, the result is the variable COUNT, which is used, inter alia, to perform the ciphering step as shown. A PDCP header is then attached to the resulting packet for its orderly delivery with respect to the other received packets. The variable “COUNT” thus provides the particular HFN associated with a particular group of 128 voice packets (assuming the SN is defined to be 7 bits long) transmitted and received over the Uu interface. Although not shown, the other protocols (RLC, MAC, PHY or L1) perform bit manipulations as per their respective procedures on the resulting packet and the overall packet is transmitted over the air interface (i.e., Uu interface) and received by the receiving equipment (either UE or eNodeB); these protocols are well known and well defined by the 4G LTE standard.

At the receive end of the PDCP, the first step is the removal of the PDCP header of a received packet, then the HFN and SN of the receive end (not the HFN of the transmit end as this information is local to the transmit end only) for the received packet are used as inputs to the deciphering step. Note that only PDCP SN is carried in PDCP header and transmitted over the air. The HFN is not transmitted. The receive end derives the HFN based on the progression of the PDCP SN. The HFN is initialized to 0 and once the received PDCP SN has reached its cycle (for 7-bit SN, the cycle is from 0 to 127) the HFN (at the received end) is incremented by 1. Also, when the received PDCP SN is less than the expected PDCP SN, the HFN (at the received end) is also incremented by 1 because the PDCP SN has wrapped around the 128 packet cycle. In sum, HFN de-synchronization will occur when 128 or more consecutive packets are lost. For example, say the PDCP receive end has received PDCP SN 10, and therefore its next expected PDCP SN is 11. Suppose the next 120 consecutive packets are lost, i.e., PDCP SN 11, 12, . . . , 127, 0, 1, 2, are lost over the air interface. When the PDCP receive end receives the next packet, which has PDCP SN 3, it will find that the received PDCP SN is less than the expected PDCP SN (which is 11). So in this case, the PDCP receive end will correctly increment the HFN by 1, as the PDCP SN has wrapped around. This requirement by 3GPP prevents HFN de-synchronization when the number of consecutive packet losses is less than 128. After the decipher process is performed on the resulting packet, the packets are ordered as per their respective sequence numbers.

Because COUNT is used to do the ciphering (assume header compression, i.e., RoHC (Robust Header Compression) is not enabled) at the transmit end, the result of the deciphering at the receive end for the same group of packets using the same HFN value will confirm that the packet has no errors or was not lost. Otherwise, if the result of the deciphering fails, then a header checksum process at the IP layer (and/or the UDP layer which may be an upper layer protocol also) will declare the packet to be erroneous. The packet was received in error because (i) the packet was adversely affected by channel conditions of the air interface or (ii) the packet was not adversely affected, but the wrong COUNT value was used to decipher the packet. That is, the COUNT used at the receive end was somehow different from the COUNT used at the transmit end, and in particular, the HFN value used at the respective transmit and receive ends were not the same; this phenomenon is referred to as Hyper Frame Number de-synchronization (HFN de-synchronization). In sum, HFN de-synchronization occurs when the incorrect COUNT is used to decipher the received packet(s) leading to an incorrect result in the deciphering steps, which results in a header checksum failure at the IP layer. Thus, the occurrence of HFN de-synchronization is an indication that voice packets are being lost and/or are being received in error. Each time an HFN de-synchronization occurs, the receive packet associated with the HFN de-synchronization does not pass the IP layer header checksum and is discarded by the IP layer.

The previous example was discussed with the assumption that the RoHC (Robust Header Compression) was disabled. In some circumstances, RoHC is enabled and thus in addition to the ciphering step, the packet goes through a robust header compression step. Correspondingly, at the receive end, the received packet, after having its PDCP header removed, goes through deciphering and header de-compression steps as shown in FIG. 3. As such, a potential decipher failure is declared if at the receive end (1) the RoHC de-compressor returns a decompression error (for example, due to Cyclic Redundancy Check (CRC) failure); or (2) the RoHC decompressed packet fails IP header checksum; or (3) the RoHC decompressed packet fails UDP checksum; or (4) the RoHC de-compressor sends a Feedback STATIC-NACK; or (5) at the transmit end, the RoHC compressor receives a Feedback STATIC-NACK, which is an indication that the corresponding PDCP receive end may be experiencing HFN de-synchronization. Any one of these five occurrences is an indication that an HFN de-synchronization may have commenced and that the number of consecutive discarded packets is to be monitored closely from that point forward. The following discussion describes in more detail the phenomenon of HFN de-synchronization and discusses a particular example of how HFN de-synchronization can occur.

Referring to FIG. 4, the status of the COUNT variable is shown at the transmit and receive ends of the PDCP for every 128-packet window (W_{N}) to illustrate the occurrence of an HFN de-synchronization. The term “window” is used to represent the time duration for the transmission or reception of 128 consecutive voice packets. At the transmit end, N 128-packet windows are transmitted where N is an integer equal to 2 or greater. At the receive end, N-k 128 packet windows are received where k is an integer equal to 1 or greater. It should be noted that the windows shown at the receive end are for illustrative purposes only; in fact there are no set windows (in terms of when they are received and their duration) at the receive end; the receive end receives asynchronously blocks of bits representing 128 packets at any time. For ease of explanation, we refer to these received blocks of packets as “windows.” In the example shown, because the number of packets received does not equal the number of packets transmitted, some packets were lost during transmission. When 128 or more consecutive packets are lost, HFN de-synchronization occurs. Note that once HFN de-synchronization occurs, (starting with W₂ in the example depicted in FIG. 4) all subsequent packets are corrupted after deciphering; this is because a packet from the transmit end has had one particular HFN value applied to it and upon reception, at the receive end, a different HFN value is applied to that same packet leading to errors in the decompression or in the deciphering or both.

Still continuing with FIG. 4, at the transmit end, the first window (W₀) starts when the first voice packet is transmitted. For the first 128 voice packets, HFN is set to 0. Thus the COUNT for W₀ is from 0 to 127. (HFN starts from 0.) The packets are processed as shown at the transmit end and transmitted over the Uu interface to the receive end. Assuming not all 128 packets were adversely affected by the radio interface, the receive end will have received some of the 128 packets and HFN will be set to 0 resulting in window W₀. For this group of packets, the HFN value at the transmitter is the same as the HFN value at the receiver, i.e., 0. It should be noted that the HFN for each group of packets at the transmit end is shown next to the group, but it should be well understood that the actual HFN is not transmitted; the HFN is shown for ease of reference and ease of explanation. At the transmit end the next window is transmitted some time later and For the 128 voice packets transmitted in that window (W₁), the HFN is set to 1. At the receive end, again assuming 128 consecutive packets have not been lost, the corresponding HFNs for the corresponding group of voice packets are equal and thus the HFNs are said to be synchronized.

The next window (W₂) will have HFN equal to 2. Unlike the first two windows however, packets transmitted during this window W₂ are all lost for whatever reason. The receive end will not perceive or detect any packets and will still be waiting for the next set of packets. Thus, the HFN for the receive end is still equal to 1. It should be noted that the windows shown for the receive end are for explanation purposes only; the receive end does not actually start and end windows as shown. At the receive end, a block of 128 voice packets are received at any point and no set time is designated for any window. The receive end simply reacts to the reception of incoming packets and does not pre-set windows or define the time instance when it should begin to receive packets. Therefore, from the standpoint of the receive end, a second set of 128 packets was received and HFN was incremented to 1. Then at some time T₁ later, a third block of 128 packets is received and therefore HFN is, once again, increased by 1, from 1 to 2. This third block of 128 voice packets just received is actually the fourth block transmitted; for whatever reason the receive end never received the third block (W₂) of 128 voice packets. HFN de-synchronization has occurred because for this group of packets that the receive end just received, the HFN is set to 2 in contrast to the HFN at the transmit end for this same group of voice packets, which is set to 3. As shown, the third group of voice packets was received at window W₃′.

There is no mechanism in place to allow the receive end to determine that it is actually at the fourth window and not the third window. The COUNT value used for the actual fourth window transmit packets at the receive end is incorrect because the HFN for the latest received set of packets should be 3 and not 2. As a result, the deciphering step and the header decompression steps will return a packet with errors and such errors will be detected at the IP layer causing the IP layer to discard the latest set of received packets. Eventually, the radio link (uplink or downlink) experiencing this HFN de-synchronization will become non-operational.

However, the HFN de-synchronization state once having started will continue indefinitely. The call will not be dropped and the transmitter will have not detected any errors and thus will continue to transmit packets. Accordingly, packets in window W₄ will be transmitted (its HFN will not equal the HFN of window W₄ at the receive end) and so on until packets in window N (i.e., W_{N}) as shown. The HFN for the receive end at window W_{N} may be N-k where k represents the number of times an HFN de-synchronization has occurred increasing difference between the transmit end HFN and the receive end HFN; k is an integer equal to 1 or greater. A subscriber at the receive end will not be able to hear the party at the transmit end. This indefinite state may continue for a relatively long time period until one of the parties decides to terminate the call. However, prior to termination of the call, an inordinate amount of resources will have been wasted and the QoE and QoS of the subscribers will have been damaged.

Note that the depiction above is for simplicity of explanation. In fact, HFN de-synchronization can occur when there are 128 or more consecutive packet losses, where such losses straddle different windows with each window having a different HFN number.

According to the above analysis with respect to FIGS. 3 and 4, it is the receive end that will be able to experience the adverse effects of the HFN de-synchronization. For the case when the receive end is a UE, it is the downlink that experiences voice failure. In this case, the eNodeB does not detect any errors and will continue to transmit voice packets to the UE. For the case when the receive end is an eNodeB, it is the uplink that experiences voice failure. The UE will not detect any errors and will continue to transmit voice packets to the eNode B. The method of the present invention as will now be discussed provides an approach to avoid the occurrence of HFN de-synchronization and to recover from an occurrence of HFN de-synchronization without a significant amount of disturbance to the communication session.

Referring now to FIG. 5, one embodiment (500) of the method of the present invention is shown for addressing the occurrence of HFN de-synchronization (as described above with respect to the PDCP) at the downlink portion of the air interface. In this case, the receiving equipment, i.e., the UE, will determine when a triggering event (a defined event) has occurred to warrant re-starting a telephone call in progress. In step 502, the UE is monitoring the voice IP packets from the IP layer. As the voice packets are received by the UE, they are processed by the stack of protocols discussed previously and as shown in FIG. 2. Also, as discussed above, packets which are received with errors or for which the IP header checksum has indicated contains errors are discarded by the IP layer.

In step 504, The UE is monitoring the packets from the IP layer to see when a packet is discarded by this layer. A discarded packet is an indication that the packet was received in error or the processing of the packet by the various protocols resulted in the header checksum of the IP layer indicating that the packet is erroneous—maybe because of HFN de-synchronization. The UE is not able to determine the specific reason for the rejection of any packet by the IP layer, but it is able to determine when an erroneous packet (i.e., a packet containing errors) was received based on the discard of the packet by the IP layer. The reason could have been due to that one packet adversely affected by the air interface or the occurrence of an HFN de-synchronization, which could last indefinitely. When RoHC is not enabled, the packet was discarded because it was received with errors possibly because the deciphering process returned an error causing the IP header checksum to fail or the deciphered packet to fail UDP checksum. In the case where the RoHC is enabled, a discarded packet indicates a potential decipher failure. More specifically, a potential decipher failure could be indicated by (1) the RoHC de-compressor returns a decompression error (for example, due to Cyclic Redundancy Check (CRC) failure); or (2) the RoHC decompressed packet fails IP header checksum; or (3) the RoHC decompressed packet fails UDP checksum; or (4) the RoHC de-compressor sends a Feedback STATIC-NACK; or (5) the RoHC compressor receives a Feedback STATIC-NACK. In step 506, The UE notes the occurrence of the first discard that it detects and records it as a count (by incrementing a ‘discard count register’, for example) representing the number of consecutive discarded packets. In step 508, the UE checks to determine whether the last consecutive discarded packet reached a defined threshold (i.e., number of consecutive discarded packets, M, documented by the discard count register where M is an integer equal to 2 or greater) set by manufacturer of the UE or which can be downloaded by the service provider (and updated at various times) onto the UE. The threshold may be based from ad hoc studies for this particular problem, or it may be based on statistical analysis as to the number of consecutive rejects that typically would indicate an HFN de-synchronization event has occurred. The threshold, in essence, represents for the provider a confidence level test that allows the provider to assert with a sufficient amount of confidence that an HFN de-synchronization is most likely the cause of a certain number of consecutive discards.

If at step 508, the value of the count in the discard count register has not surpassed the threshold, the method of FIG. 5 returns to step 502 and continues to monitor discarded packets and recording such discards as outlined in steps 504 and 506. Note that even after relatively many consecutive discard packets, a next packet received is not discarded, then the discard count register is reset to zero. It is the number of consecutive discarded packets that is being monitored not the number of discarded packets. However, if at step 508, the discard count has now reached the threshold, then a triggering event is defined to have occurred causing the method of the present invention to move to step 510. The triggering event refers to the reception of a certain number of consecutive erroneous voice packets reaching (or equaling) a sufficiently high threshold amount that would most likely result in the link through which the packets are received becoming non-operational. The triggering event also refers to when the length of time during which consecutive erroneous voice packets are received surpasses a defined threshold. It should be noted that the threshold or the timer value are adjustable for both the uplink and the downlink and may be adjusted by operators of the network as warranted. At this point, the link through which the received packets traversed will most likely become non-operational if a voice communications re-establishment procedure is not started. The voice or data (or both) communications reestablishment procedure is a defined procedure (e.g., a network defined procedure or a communication standard defined procedure) that allows communications to be established once again for the communication session in progress. For the case being discussed the communication reestablishment procedure is initiated by the network element (i.e., UE or eNodeB) that has detected the discard of voice packets by the IP.

For example, in step 510, the UE may initiate an RRC (Radio Resource Control) Re-establishment protocol, one version of which is a procedure specifically defined by the 3GPP TS 36.331 V 1.0.0 release 8 protocol of the 4G LTE standard, which is incorporated herein by reference in its entirety; see for example, section 5.2.4 of TS 36.331 V 1.0.0 release 8), which provides, in detail, how the UE is to communicate with the eNodeB to allow both the UE and the eNodeB to reset certain network parameters (including SN and HFN) associated with re-establishing a telephone call. In step 512, the RRC Re-establishment procedure is completed by the UE and the eNodeB. The method of the present invention then moves to step 514 where the UE also resets the contents of the discard count register to zero. At this point, the telephone call has been re-established and the UE moves to step 502, where it continues to monitor voice packets from the IP layer. It should be noted that all of the steps of the flow chart of FIG. 5 are performed by a UE or a terminal (fixed or mobile) capable of gaining access to the network via the proper interface (e.g., the Uu interface).

Referring now to FIG. 6, another embodiment (600) of the method of the present invention is shown for addressing the occurrence of HFN de-synchronization at the uplink portion of the air interface. In this case, the receiving equipment, i.e., the eNodeB, will determine when a triggering event has occurred to warrant re-establishing a communication session (e.g., a telephone call) in progress, but with one of the links being non-operational or will be non-operational if not steps are taken. In step 602, the eNodeB is monitoring the voice IP packets from the IP layer. As the voice packets are received by the eNodeB, they are processed by the stack of protocols previously discussed and shown in FIG. 2. Also, as discussed above, packets which are received with errors or for which the IP header checksum has indicated contain errors are discarded by the IP layer.

In step 604, the eNodeB is monitoring the packets from the IP layer to see when a packet is discarded by this layer. A discarded packet is an indication that the packet was received in error or the processing of the packet by the various protocols resulted in the header checksum of the IP layer indicating that the packet is erroneous. The eNodeB is not able to determine the specific reason for the rejection of any packet by the IP layer, but it is able to determine when an erroneous packet (i.e., a packet containing errors) was received based on the discard of the packet by the IP layer. The reason could have been due to that one packet adversely affected by the air interface or the occurrence of an HFN de-synchronization, which could last indefinitely.

In step 606, the eNodeB notes the occurrence of the first discard that it detects and records it as a count (by incrementing a ‘discard count register’, for example) representing the number of consecutive discarded packets. Alternatively, the eNodeB can start a timer set at a threshold time period, and maintain the timer as long as erroneous consecutive voice packets are being received. If a string of erroneous consecutive packet is broken with acceptable packets, the timer is reset if it hasn't yet lapsed. The lapsing of the timer indicates when a triggering event has occurred meaning that the link through which the packets are traversing will likely become non-operational if a re-establishment procedure is not initiated. In step 608, the eNodeB checks to determine whether the last consecutive discarded packet reaches a defined threshold (i.e., number, M, of consecutive discarded packets from the discard count register where M is an integer equal to 2 or greater) set by the service provider and/or owner of the network; alternately, the eNodeB can check to determine if the timer has lapsed. The threshold may be based from ad hoc studies for this particular problem, or it may be based on statistical analysis as to the number of consecutive discards (or the amount of time it would take) that typically would indicate an HFN de-synchronization event has occurred and that re-establishment of voice communications is required. The threshold, in essence, represents for the provider a confidence level test that allows the provider to assert with a sufficient amount of confidence that an HFN de-synchronization is most likely the cause of a certain number of consecutive discards or consecutive discards lasting beyond a specific time period.

If at step 608, the value of the count in the discard count register has not surpassed the threshold (or the timer has not lapsed), the method of FIG. 6 returns to step 602 and continues to monitor discarded packets and recording such discards as outlined in steps 604 and 606. The timer is reset or the discard timer count is set to zero when one or more packets are received without errors. However, if at step 608, the discard count has now surpassed the threshold, then by definition a triggering event has occurred causing the method of the present invention to move to step 610. At that point, the link through which the received packets traversed will most likely become non-operational if a voice communications re-establishment procedure is not started. It should be noted that the threshold or the timer value are adjustable for both the uplink and the downlink and may be adjusted by operators of the network as warranted. The method of the present invention will initiate a voice communications reestablishment procedure, which is a defined procedure (e.g., a network defined procedure) that allows communications to be established once again for the communication session in progress.

In step 610, the eNodeB will initiate an intra-cell Handover, which is in effect a Handover from the eNodeB to itself. One version of a Handover is a procedure defined in detail by 3GPP TS 36.331, V 8.2.0 (Release8), sec. 5.4.2, which is incorporated herein by reference in its entirety. The Handover dictates how the eNodeB is to communicate with the UE to allow the UE and the eNodeB to reset certain network parameters (including SN and HFN) associated with transferring control from a previously serving cell to a new serving cell into which the UE has physically entered. In the case of an intra-cell handover, the eNodeB, which already was serving the UE is transferring control back to itself to serve the same cell and the same UE that is still physically located in that cell. In step 612, the intra-cell Handover procedure is completed by the UE and the eNodeB. The method of the present invention then moves to step 614 where the eNodeB also resets the contents of the discard count register to zero. At this point, the telephone call has been re-established and the eNodeB moves to step 602, where it continues to monitor voice packets from the IP layer. It should be noted that all of the steps of FIG. 6 are performed by an eNodeB.

Referring now to FIG. 7, a flow chart of an embodiment of the method (700) of the present invention for data packets is shown. As with the voice packets of the previous embodiments, the air interface protocols process the incoming data packets as per the specific procedures outlined in the standard. For data packets transmitted over the uplink portion of the air interface, we focus on the Radio Link Control (RLC) protocol, which unlike the PDCP, is an ACK/NACK procedure whereby the receiving end confirms the reception of every packet to achieve error free communication. Prior to the start of transmission of the data packets, a communication session between the UE and the eNodeB is established. One version of the RLC protocol is defined in detail in the 3GPP TS 36.322, V2.0.0, Release 8 protocol of the 4G LTE standard, which is incorporated herein by reference in its entirety. See for example, a block diagram representing the various steps performed by the RLC protocol in Sec. 4.2.1.3.1, FIG. 2.1.3.1-1 of TS 36.322. As with the voice packets, a data packet transmitted by a UE over an uplink to an eNodeB is sometimes lost or is sometimes received with errors. The RLC protocol, which operates in the UE and in the eNodeB, causes the UE to wait for an ACK or NACK message from the eNodeB for every data packet that was transmitted by the UE. If the UE receives a NACK message from the eNodeB for a particular packet, the UE has to re-transmit that packet. In some cases, the data packet is lost each time it is transmitted and the UE will still receive NACKs for a particular packet for an inordinately lengthy period. During such a period, the uplink is effectively non-operational and system resources are being wasted. The data communications has, in effect, been halted. In this case, the UE will request a re-establishment of the connection to salvage the communications. However, for the case of data packet transmission by the eNB on the downlink, there is no standard specification for a recovery procedure and thus the connection would have to be dropped eventually. In order to avoid such failures the method of FIG. 7 performs the following steps.

In step 702, the eNodeB monitors the output of the RLC protocol to determine if the RLC protocol at the eNodeB has received a NACK based on data packets transmitted by the eNodeB. The failure to receive an ACK within the required time interval is also regarded as a NACK reception. In particular, in step 704, the eNodeB is checking for the reception of a NACK indicating that a packet transmitted by the eNodeB was received with errors or was not received at all. If an ACK is received by the eNodeB, the method of the present invention moves back to step 702 as this indicates that the packet transmitted by the eNodeB was received without any errors. However, if a NACK is received by the eNodeB, the method of the present invention moves to step 706 where the eNodeB retransmits the data packet and increments a retransmit counter for that packet. In step 708, if after having incremented the retransmit counter (i.e., the number of times a particular packet has been retransmitted) the retransmit counter has reached a set threshold (set by system operators, for example), the method of the present invention moves to step 710; otherwise, the method of the present invention returns to step 702. In step 710 a triggering event has occurred and thus the eNodeB initiates an intra-cell handover. The threshold represents a confidence level indicator that allows the service provider to assert with some certainty that the connection between the UE and the eNodeB has likely become non-operational when the number of retransmission has passed the set threshold. Instead of a retransmit counter, another embodiment of the method of the present invention can use a timer that runs as long as NACK is being received in response to a transmission by the eNodeB. When such a timer lapses with NACKs still being received, a triggering event has occurred and an intra-cell handover is started. The amount of time set for the timer is another level of confidence statistically or heuristically developed by system designers. In step 712, the retransmit counter is reset after the handover has been completed.

The intra-cell handover is much like a regular handover as defined, for example, in the 3GPP TS 36.331 V8.2.0 Release 8 protocol of the 4G LTE standard. As explained earlier, in the case of the intra-cell handover, the UE is treated much like a UE that is in the process of entering the cell being served by the eNodeB. The previous eNodeB, which had been serving the UE transfers much of the system parameters needed for the handover to the new eNodeB. In the case of the intra-cell handover, the eNodeB initiating the handover is also the previous eNodeB. Thus, the parameters needed from the ‘previous’ eNodeB are already in the possession of the eNodeB. Once these parameters are confirmed by the eNodeB, it performs a handover with the UE as per the handover protocol. It will be readily understood the intra-cell handover may be implemented without having to comply with any particular protocol set by any communication standard committee. The intra-cell handover may be any accepted communications reestablishment procedure that allows a communications session to be re-started; it does not have to be implemented as an established and defined protocol some of which have been cited herein. It will be further noted that any particular protocol disclosed herein includes various versions of that protocol (not necessarily cited or disclosed herein) that contain the aspects of the protocol for which it is cited. Herein.

While various aspects of the invention have been described above, it should be understood that they have been presented by way of example and not by limitation. It will be apparent to persons skilled in the relevant art(s) that various changes in form and detail can be made herein without departing from the spirit and scope of the present invention. Thus, the present invention should not be limited by any of the above-described exemplary aspects, but should be defined only in accordance with the following claims and their equivalents.

What is claimed is:

1. A method comprising:
determining, by a network element of a cellular network, reception of an erroneous voice packet over an air interface of the cellular network based on at least one step performed by the network element in response to the reception of the erroneous voice packet and in accordance with at least one protocol of the air interface; and
initiating, by the network element, a voice communications reestablishment procedure over the air interface upon an occurrence of a triggering event based on received erroneous voice packets.

2. The method of claim 1 where the network element is a base station.

3. The method of claim 1 where the network element is a mobile terminal.

4. The method of claim 1 where the at least protocol is a protocol of the air interface of the cellular network.

5. The method of claim 1 where the cellular network is a 4G LTE network.

6. The method of claim 5 where the network element is a UE.

7. The method of claim 5 where the network element is an eNodeB.

8. The method of claim 5 where the air interface is a Uu interface of the 4G LTE network.

9. The method of claim 5 where the at least one protocol is an Internet Protocol (IP) and a Packet Data Convergence Protocol (PDCP) with header compression and decompression disabled.

10. The method of claim 9 where the at least one step performed by the network element in accordance with the at least one protocol comprises discarding one or more erroneous voice packets received over the air interface due to failure of IP header checksum by a deciphered packet.

11. The method of claim 5 where the at least one protocol is an Internet Protocol (IP) and a Packet Data Convergence Protocol (PDCP) with header compression and decompression enabled.

12. The method of claim 11 where the at least one step performed by the network element comprises discarding one or more erroneous voice packets received over the air interface due to failure of IP header checksum by a deciphered packet where the header decompression returns an error.

13. The method of claim 5 where the triggering event occurs when M consecutive erroneous voice packets have been received where M reaches a network defined threshold and where M is an integer equal to 2 or greater.

14. The method of claim 5 where the triggering even occurs when consecutive erroneous voice packets are received until a network defined timer has lapsed, said timer being initiated upon reception of a first erroneous voice packet.

15. The method of claim 6 where the air interface is an uplink of a Uu interface of the 4G LTE network.

16. The method of claim 6 where the UE is a cellular telephone.

17. The method of claim 6 where the voice communications re-establishment procedure is an RRC re-establishment procedure in accordance with a version of 3GPP TS 36.331.

18. The method of claim 7 where the air interface is a downlink of a Uu interface of the 4G LTE network.

19. The method of claim 7 where the voice communications re-establishment procedure is an intra-cell handover in accordance with a version of 3GPP TS36.331.

20. A device comprising:
a processor;
a receiver circuit coupled to the processor, the processor being in direct communication with an air interface of a cellular communication network, where voice packets received by the receiver over the air interface are processed by the processor in accordance with at least one air interface protocol of the cellular network to determine reception of erroneous voice packets and, upon the occurrence of a triggering event, to initiate a voice communications re-establishment procedure based on reception of the erroneous voice packets.

21. The device of claim 18 where the processor and the receiver reside in a base station of the cellular network.

22. The device of claim 18 where the processor and the receiver reside in a mobile terminal.

23. A method comprising:
determining, by a network element, reception of erroneous data packets over an air interface of a cellular network based on a message transmitted by the network element, in accordance with at least one protocol of the air interface, in response to the reception of the erroneous data packet; and
initiating, by the network element, a data communications re-establishment procedure over the air interface upon an occurrence of a triggering event based on the transmitted message.

24. The method of claim 21 where the network is a 4G LTE network.

25. The method of claim 22 where the network element is an eNodeB.

26. The method of claim 22 where the data communications re-establishment procedure is an intra-cell handover operated as per a version of 3GPP TS 36.331 protocol.

27. The method of claim 22 where the air interface is an uplink of a Uu interface of the 4G LTE network.

28. The method of claim 22 where the transmitted message is a NACK message.
